(19) United States
(12) Patent Application Publication
(10) Pub. No.: US 2026/0227808 A1
(43) Pub. Date: Aug. 6, 2026

(54) CO2 BLEED-OFF PROCESS WITH EQUIPMENT PRESERVATION DURING TEMPORARY CO2 INJECTION PROCESS

(71) Applicant: Schlumberger Technology Corporation, Sugar Land, TX (US)

(72) Inventors: Yannick Sabin, Clamart (FR); Jamie Gibb, Aberdeen (GB); Iakov Shumakov, Bucharest (RO); David Mackinnon, Aberdeen (GB); Samir Terghini, Clamart (FR); Aydyn Agayev, Aberdeen (GB); Vincent Pequignot, Clamart (FR); Bertrand Claude Theuveny, Paris (FR)

(21) Appl. No.: 19/529,252

(22) Filed: Feb. 4, 2026

Related U.S. Application Data
(60) Provisional application No. 63/753,614, filed on Feb. 4, 2025.

(51) Int. Cl. G05D 16/00

(52) U.S. Cl. CPC G05D 16/028

(57) ABSTRACT

A method of depressurizing a volume of trapped CO₂. The method including injecting displacement fluid in a closed system to displace the volume of trapped CO₂ and releasing the trapped CO₂ out of the trapped system through a depressurization line while maintaining pressure in the closed system above a CO₂ saturation pressure.

### CROSS-REFERENCE TO RELATED APPLICATION

This application claims benefit of U.S. Provisional Patent Application No. 63/753,614 filed on Feb. 4, 2025, which is hereby incorporated by reference in its entirety for all purposes.

### BACKGROUND

The present disclosure generally relates to systems and methods for CO₂ bleed-off for equipment preservation.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Many well testing operations involve temporary injection of CO₂, both in liquid and gas phases, into reservoirs. Injection of CO₂ into reservoirs may be performed during reservoir evaluation purposes to assess a reservoir's potential for CO₂ storage. Well testing operations may use traditional well-test equipment designed to test the exploration and appraisal wells drilled in oil, water, and gas-bearing reservoirs. However, traditional well-test equipment may not be suitable for handling CO₂ under a wide range of potential conditions, particularly due to high-pressure and low-temperature characteristics of CO₂ in various states. Design and use of low-temperature cryogenic equipment for such well testing operations may be expensive or operationally impractical. Thus, a need exists to reduce the costs and complexity associated with preserving standard well-test equipment from pressure and temperature limits during injection of CO₂.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, a method of depressurizing a volume of trapped CO₂ is provided. The method including injecting displacement fluid in a closed system to displace the volume of trapped CO₂ and releasing the trapped CO₂ out of the trapped system through a depressurization line while maintaining pressure in the closed system above a CO₂ saturation pressure.

In certain embodiments, a depressurization system is provided herein. The depressurization system includes a closed system, including at least a conduit, configured to include a volume of trapped CO₂ and an injection inlet coupled to a first portion of the closed system, wherein the injection inlet is configured to inject a displacement fluid into the closed system. The depressurization system also includes a depressurization line coupled to a second portion of the closed system, wherein the first and second portions are offset from one another. The depressurization system also includes a cryogenic valve coupled to the depressurization line, wherein the cryogenic valve is configured to control a release of the trapped CO₂ out of the closed system through the depressurization line.

In certain embodiments, a method is provided. The method includes determining if a volume of trapped CO₂ within a closed system is in a liquid or supercritical state and in response to the volume of trapped CO₂ being in the liquid or supercritical state, reducing the pressure of the closed system by bleeding off the pressure while keeping the pressure in the closed system above the saturation pressure of CO₂. The method also includes injecting a displacement fluid to release CO₂ through a depressurization line while maintaining the pressure in the closed system above the CO₂ saturation pressure and performing one or more pressure bleed offs to ambient conditions releasing the displacement fluid through the depressurization line.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a CO₂ phase diagram, in accordance with aspects of the present disclosure;

FIG. 2 is a graph of pressure versus temperature for trapped liquid CO₂ in a closed system at an initial pressure of 1500 psi, in accordance with aspects of the present disclosure;

FIG. 3 is a graph of pressure versus temperature for trapped liquid CO₂ in a closed system at an initial pressure of 100 psi, in accordance with aspects of the present disclosure;

FIG. 4 is a graph of pressure versus temperature for trapped liquid CO₂ in a closed system at an initial pressure of 250 psi, in accordance with aspects of the present disclosure;

FIG. 5 is a graph of simulated pressure and temperature conditions in a trapped CO₂ volume during a direct bleed-off process, in accordance with aspects of the present disclosure;

FIG. 6 is a schematic illustration of a depressurization system including a depressurization line, in accordance with aspects of the present disclosure;

FIG. 7 is a schematic illustration of the depressurization line of the depressurization system, in accordance with aspects of the present disclosure;

FIG. 8 is a flow chart of an embodiment of a process for injecting a displacement fluid to release CO₂ through a depressurization line, in accordance with aspects of the present disclosure; and

FIG. 9 is a flow chart of an embodiment of a process for performing CO₂ displacement by injecting a displacement fluid through a depressurization line, in accordance with aspects of the present disclosure;

FIG. 10 is a graph illustrating a phase envelope of CO₂ during a depressurization process from initial to ambient conditions, in accordance with aspects of the present disclosure; and

FIG. 11 is a graph illustrating a phase envelope of CO₂ including simulated pressure and temperature during the depressurization process of FIG. 11, according to one or more examples of the disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

As used herein, the term “processing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM).

The present disclosure is generally directed towards systems and methods for preserving standard well-test equipment from low temperatures during depressurization of trapped carbon dioxide (CO₂) in well testing equipment. Embodiments herein describe a depressurization system that may be used to extend an operational range of standard well equipment. The depressurization system may be used to displacing a volume of well-test equipment occupied by CO₂ with a displacement fluid. The displacement fluid may include a non-reactive gas or liquid, such as one or more inert gases (e.g., nitrogen (N₂), argon (Ar)), methanol, flue gas, air, steam, mono ethylene glycol, and the like. The depressurization system may be used to control a pressure bleed-off process through a depressurization line of the depressurization system. The depressurization system may reduce overall operational costs if well testing, and enhance safety by displacing trapped CO₂ with non-reactive fluids through the depressurization line specifically designed to handle CO₂ temperature and pressure limits.

During a temporary CO₂ injection process of a surface production facility, there may be one or more instances in which the injection of CO₂ may be halted, leaving a volume of CO₂ trapped in the surface production facility. Depending on a pressure and a temperature of CO₂ during an injection stage and consequently the pressure and temperature of the trapped CO₂, the CO₂ may exist in the form of a gas, liquid, or supercritical fluid. The temperature of the trapped CO₂ is subject to change due to heat transfer from one or more internal elements of the surface production facility and/or a natural warming effect from surrounding ambient conditions. Differences between the initial temperature of the trapped CO₂ and the surrounding ambient temperature may pose risks to equipment of the surface production facility. Although surface production facilities are equipped with safety systems, such as pressure safety valves and relief lines, to reduce the possibility of pressures exceeding maximum operating pressures, the safety systems are intended for emergency use and may not be suitable for use in routine pressure bleed-off operations. As such, the depressurization system and method described herein may be used to control pressure bleed-off and/or may be used before decommissioning equipment of the surface production facility.

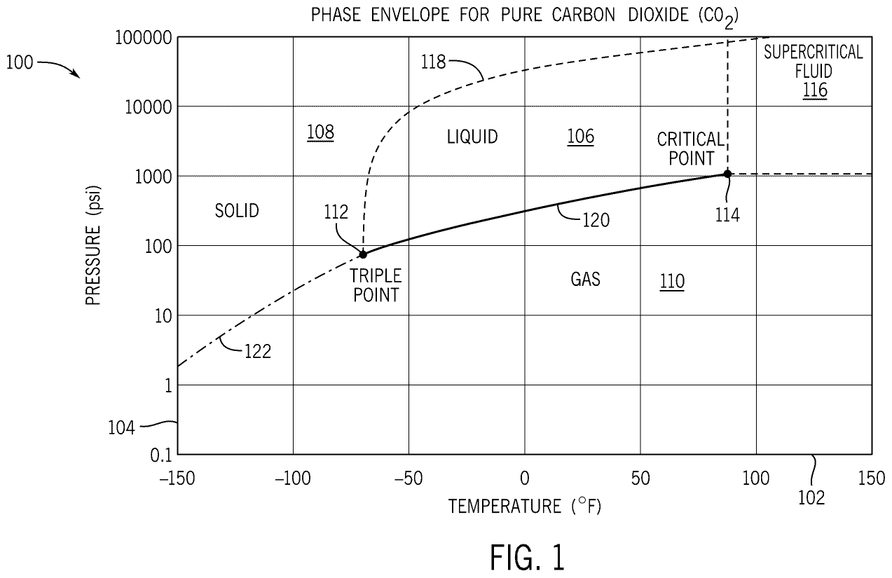

With the foregoing in mind, FIG. 1 is a CO₂ phase diagram 100, in accordance with aspects of the present disclosure. The CO₂ phase diagram 100 includes an x-axis 102 of temperature in Fahrenheit (° F.) and a y-axis 104 of pressure in pounds per square inch (psi). The CO₂ phase diagram 100 includes a liquid phase 106, a solid phase 108, a gaseous phase 110, the triple point 112 (e.g., point at which the liquid phase 106, the solid phase 108, and the gaseous phase 110 coexist), and the critical point 114 (e.g., point at which CO₂ is indistinguishable between the liquid phase 106 and the gaseous phase 110) identifying a supercritical fluid envelope 116. The CO₂ phase diagram 100 includes a fusion curve 118, a vaporization curve 120, and a sublimation curve 122. As shown in FIG. 1, depending on an injection temperature of CO₂, pressure bleed-off for CO₂ in the gas phase, the liquid phase, or supercritical state may be considered.

CO₂ in its liquid or supercritical state is similar to other low-compressibility liquid, exhibiting significant pressure changes in a closed system as the temperature varies. Pressure changes in the closed system filled with CO₂, due to temperature change, may be calculated by determining the vapor pressure using the Antoine equation shown in Equation 1,

$${log}_{10} ( P ) = A - \frac{B}{C + T}$$

where P is the pressure, T is temperature, and A, B, and C are substance-dependent parameters. The parameters for CO₂ are: 154.26 K to 195.89 K: A=6.81228, B=1301.679, C=−3.4940, 194.67 K to 273.15 K: A=7.28206, B=1321.653, C=−32.445, and 273.15 K to 303.15 K: A=7.43155, B=1361.453, C=−40.536.

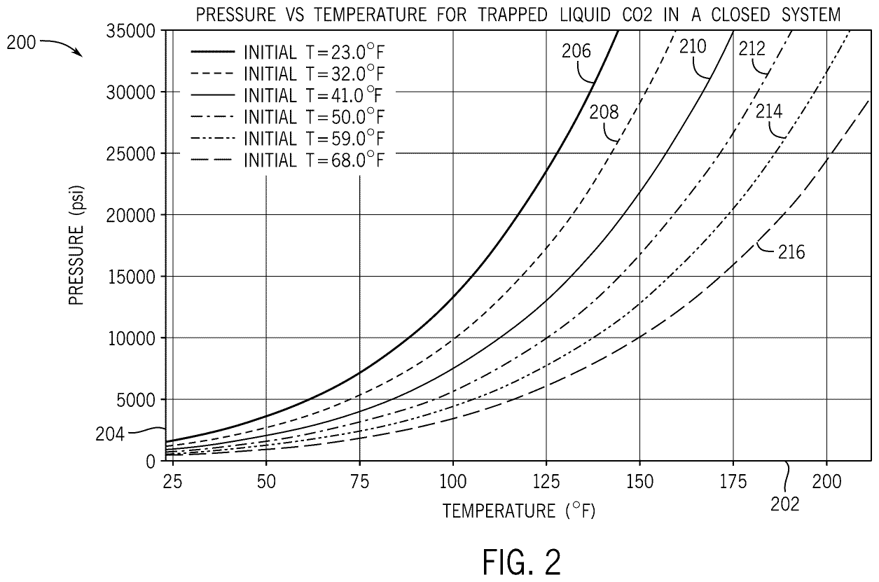

FIGS. 2-4 illustrate pressure versus temperature changes for trapped CO₂ in a closed system at various initial temperatures. As shown in FIGS. 2-4, behavior of CO₂ in its gaseous state is similar to that of other gases, characterized by high compressibility and, therefore, lead to less pressure changes of a closed system with temperature changes. However, if the pressure of the closed system reaches the saturation pressure of CO₂ (e.g., the specific pressure where liquid and gaseous CO₂ coexist in equilibrium at a given temperature) the CO₂ will transition to the liquid or supercritical phase, exhibiting properties of the liquid phase system, which include less compressibility and higher pressure sensitivity to temperature changes.

FIG. 2 is a graph 200 of pressure versus temperature for trapped liquid CO₂ in a closed system at an initial pressure of 1500 psi, in accordance with aspects of the present disclosure. The graph 200 includes an x-axis 202 of temperature in Fahrenheit (° F.) and a y-axis 204 of pressure in pounds per square inch (psi). The graph 200 includes various traces of the pressure versus temperature for trapped CO₂ at an initial pressure of 1500 psi. The graph 200 includes an initial 23° F. trace 206, an initial 32° F. trace 208, an initial 41° F. trace 210, an initial 50° F. trace 212, an initial 59° F. trace 214, and an initial 68° F. trace 216. As shown, in a closed system pressure and temperature are directly proportional, as temperature increases, pressure increases. If liquid CO₂ is present, the pressure follows the saturation curve while above the critical point, the CO₂ may act as a supercritical fluid, where pressure changes without phase change.

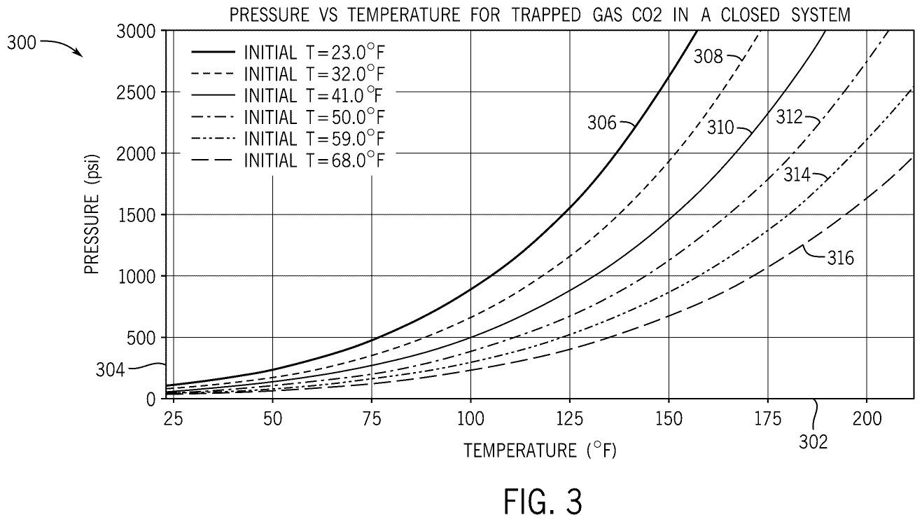

FIG. 3 is a graph 300 of pressure versus temperature for trapped liquid CO₂ in a closed system at an initial pressure of 100 psi, in accordance with aspects of the present disclosure. The graph 300 includes an x-axis 302 of temperature in Fahrenheit (° F.) and a y-axis 304 of pressure in pounds per square inch (psi). The graph 300 includes various traces of the pressure versus temperature for trapped CO₂ at an initial pressure of 100 psi. The graph 300 includes an initial 23° F. trace 306, an initial 32° F. trace 308, an initial 41° F. trace 310, an initial 50° F. trace 312, an initial 59° F. trace 314, and an initial 68° F. trace 316. The liquid CO₂ present at the initial pressure of 100 psi follows the saturation curve of CO₂.

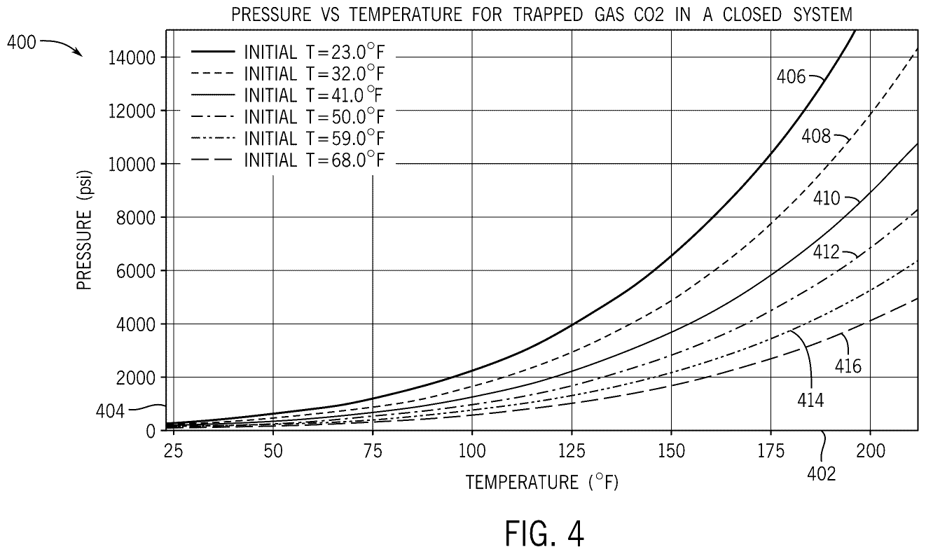

FIG. 4 is a graph 400 of pressure versus temperature for trapped liquid CO₂ in a closed system at an initial pressure of 250 psi, in accordance with aspects of the present disclosure. The graph 400 includes an x-axis 402 of temperature in Fahrenheit (° F.) and a y-axis 404 of pressure in pounds per square inch (psi). The graph 400 includes various traces of the pressure versus temperature for trapped CO₂ at an initial pressure of 250 psi. The graph 400 includes an initial 23° F. trace 406, an initial 32° F. trace 408, an initial 41° F. trace 410, an initial 50° F. trace 412, an initial 59° F. trace 414, and an initial 68° F. trace 416. The liquid CO₂ present at the initial pressure of 250 psi is further along the saturation curve as compared to FIG. 3 illustrating behavior of CO₂ at an initial pressure of 100 psi.

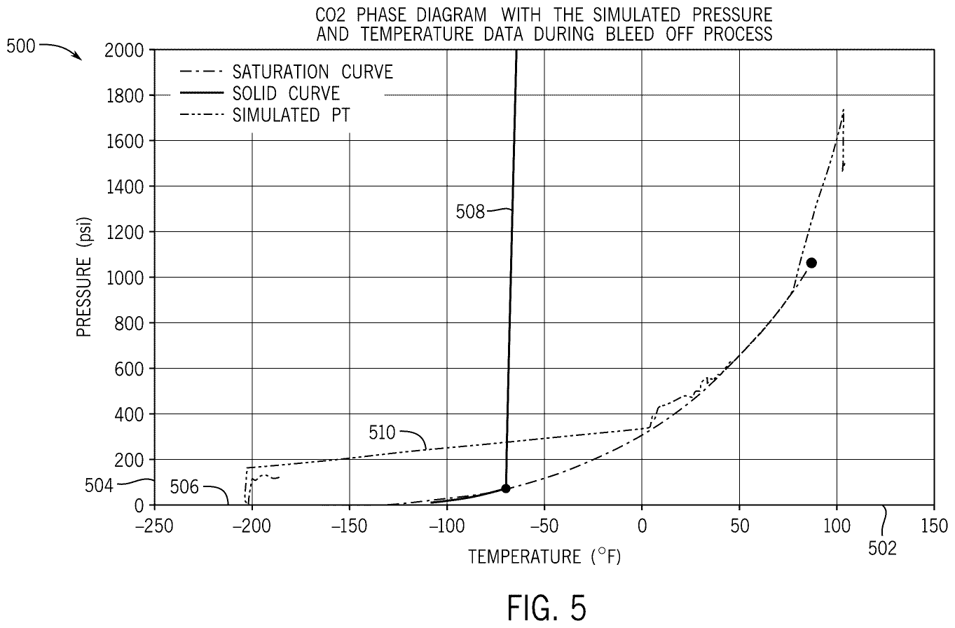

FIG. 5 is a graph 500 of a CO₂ phase diagram including simulation of pressure and temperature conditions in a trapped CO₂ volume during a direct bleed-off process with an initial pressure of 1500 psi, in accordance with aspects of the present disclosure. The graph 500 has an includes an x-axis 502 of temperature in Fahrenheit (° F.) and a y-axis 504 of pressure in pounds per square inch (psi). The graph 500 includes a CO₂ saturation curve 506, a CO₂ solid curve 508, and a simulated trace 510 of pressure and temperature data during the direct bleed-off process. The simulated trace 510 illustrates how pressure and temperature conditions of the trapped CO₂ change as the CO₂ reaches saturation conditions where it transitions from a liquid to a gas phase causing a cooling effect. The closed system may reach equilibrium conditions along the saturation curve 506 as the temperature decreases.

In some implementations, the direct bleed-off of liquid or supercritical CO₂ to ambient conditions involves several steps. For example, trapped CO₂ in a closed system may be in an initial state (e.g., liquid phase, supercritical phase) above a critical pressure (73.8 atm). In the initial state, the CO₂ may have properties of a liquid in the case of being in the liquid phase or properties of both a liquid and a gas in the supercritical state. The first step in the direct bleed-off process may include gradually reducing the pressure through a series of valves and/or pressure regulators to avoid rapid depressurization. Rapid depressurization may lead to cooling and/or potential solidification of CO₂ within the closed system. As the pressure is reduced, the temperature may be managed to reduce the possibility of rapid temperature drops of the CO₂ in the closed system. The temperature may be managed by controlling a bleed-off rate of the closed system. As the pressure decreases, CO₂ will eventually reach saturation conditions where the CO₂ transitions from a liquid state to a gas. This phase transition causes a significant cooling effect that surrounding heat cannot offset. Even at a small bleed-off rate, the closed system reaches equilibrium conditions along the saturation curve as the temperature decreases. This process is visualized by FIG. 5, wherein the pressure bleed-off process is illustrated using a transient process simulator. The graph 500 shows simulated pressure and temperature conditions in a trapped CO₂ volume during the direct bleed-off process from the initial 1500 psi of CO₂ in the supercritical state to ambient conditions.

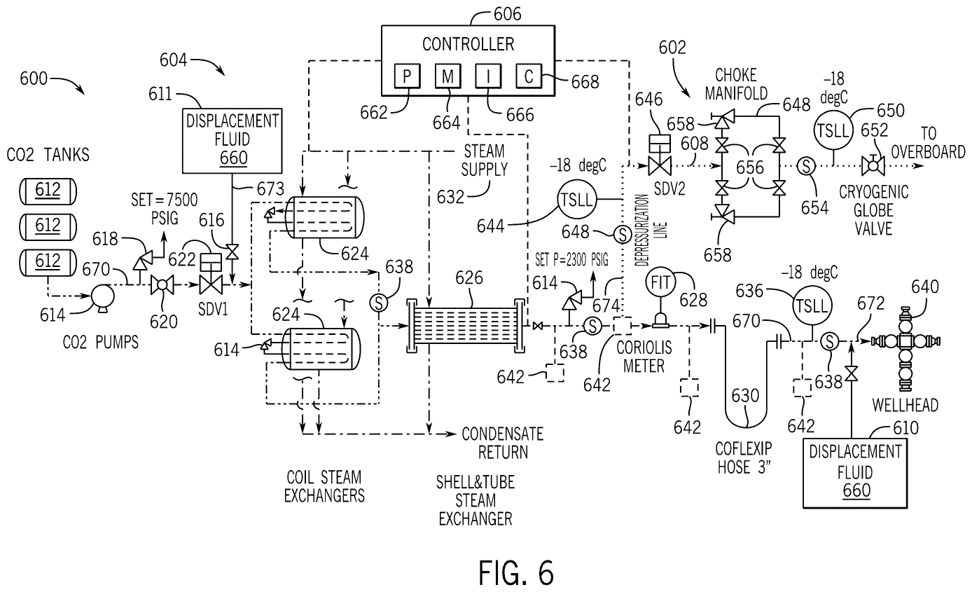

To reduce the possibility of formation of solid CO₂ (e.g., dry ice) which may occur if the temperature drops, extensive heat may be supplied to the trapped CO₂ in the closed system. Applying extensive heat, typically involves pumping the trapped volume through a circulation loop and heat exchangers, which may not be practically feasible in many cases. Further, a remaining CO₂ gas volume may be released to the atmosphere reducing the pressure in the trapped CO₂ volume to ambient conditions. Release of the remaining CO₂ gas volume may be managed to ensure safety and efficiency, as rapid volume expansion may cause cooling and potential hazards. The pressure bleed-off process of carbon dioxide in its gas phase to ambient conditions involves several risks associated with rapid temperature drop below the equipment and piping design criteria. As such, a direct bleed-off process is described herein in regards to FIGS. 6-11 below.

As previously described, the pressure bleed-off process of trapped CO₂, whether in liquid, supercritical, or gas phase, presents several technical and safety challenges. To address these challenges, a depressurization system is described herein. The depressurization system may control displacement of trapped volume of CO₂ in the liquid or supercritical state with a displacement fluid e.g., a non-reactive fluid such as one or more inert gases (e.g., nitrogen (N₂), argon (Ar)), methanol, flue gas, air, steam, mono ethylene glycol, and the like) while maintaining a pressure of the trapped volume of CO₂ above the CO₂ saturation pressure. This displacement may be achieved by injecting a displacement fluid at a first end of a closed system and releasing trapped CO₂ into the atmosphere through a dedicated, low-temperature rated, instrumented depressurization line. An outlet of the depressurization line may be positioned at a second end of a closed system, offset from an inlet in which the displacement fluid is injected at the first end. In other words, the inlet for the injection of the displacement fluid is offset away from the outlet for the release of the trapped CO₂, such that the displacement fluid flows through the closed system to displace and move the trapped CO₂out of the closed system. The depressurization system, according to some embodiments, may include any number of inlets (e.g., 1, 2, 3, 4, 5, 6, 7, 8, 9, 10, or more inlets) for the injection of displacement fluid and any number of outlets (e.g., 1, 2, 3, 4, 5, 6, 7, 8, 9, 10, or more outlets) for the release of the trapped CO₂, wherein the inlets and outlets are offset from one another by some fluid volume and/or fluid passages having the trapped CO₂. In some embodiments, each inlet may be coupled to the same or different displacement fluid supply, and each outlet may be coupled to the same or different depressurization circuit (e.g., one or more depressurization lines). The depressurization line may be used to bleed off remaining pressure of the closed system, once the displacement fluid has replaced the trapped volume of CO or if the trapped CO is in the gas state.

FIG. 6 is a schematic illustration of a system 600 including a depressurization system 602 and a carbon capture and storage (CCS) injection testing system 604, in accordance with aspects of the present disclosure. The system 600 may include a controller 606. The controller 606 may be used to control one or more pieces of equipment of the system 600. The depressurization system 602 may include a depressurization line 608, one or more displacement fluid supply lines 610, 611, and/or one or more additional components. As discussed below, the depressurization system 602 controls the discharge of trapped CO₂ through the depressurization line 608 compensated by displacement fluid 660 from the displacement fluid supply lines 610, 611 (e.g., nitrogen) into a closed system (e.g., CCS injection testing system 604), thereby controlling the pressure in the closed system (e.g., CCS injection testing system 604 and/or reservoir) to exceed the saturation pressure of CO₂. Thus, by controlling the pressure in the closed system (e.g., CCS injection testing system 604 and/or reservoir) to exceed the saturation pressure of CO₂, the depressurization system 602 helps to reduce the possibility of sudden pressure and temperature changes that can lead to solidification of the CO₂ in the closed system (e.g., CCS injection testing system 604 and/or reservoir) and/or impact a structural integrity of equipment of the system 600.

The CCS injection testing system 604 may include one or more components such as one or more CO₂ tanks 612, one or more CO₂ pumps 614, one or more valves 616, one or more angle valves 618, one or more globe valves 620, one or more shut down valves 622, one or more heat exchangers such as case coil steam exchangers 624, a shell and tube steam exchanger 626, a Coriolis meter 628, one or more high pressure hoses 630 (e.g., COFLEXIP Hose), a steam supply line 632, one or more Temperature Switch Low-Low (TSLL) components 636, one or more sensors 638, and the like coupled to a well head 640 of a subterranean well. The components and equipment of the CCS injection testing system 604 may include equipment rated for oil and gas exploration, but may not be rated for low temperature conditions. For example, the components and equipment may be 150, 300, 600, 900, and the ASME B16.5 rated for classes rated for pressure conditions ranging from 285 psi to 2200 psi and temperatures from −20° F. to 600° F.

The depressurization line 608 of the depressurization system 602 may be positioned at one or more positions 642 of the CCS injection testing system 604. In certain embodiments, the depressurization system 602 may be positioned at the one or more positions 642 directly at, upstream from, and/or downstream from each of the illustrated components (e.g., 624, 626, 628, 630). As shown, the depressurization line 608 may be positioned downstream of the shell and tube steam exchanger 626 and upstream of the Coriolis meter 628. The depressurization line 608 may include a first TSLL component 644, a shutdown valve 646, a choke manifold 648, a second TSLL component 650, a cryogenic globe valve 652, one or more sensors 654, one or more additional components, or any combination thereof. The choke manifold 648 may include one or more valves 656, one or more angle valves 658, or any combination thereof. The components and equipment of the depressurization system 602 may be rated for cryogenic temperatures, such as temperatures below −200° F. In this manner, the depressurization system 602 may be used to perform depressurization management including bleed-off.

In some implementations, the controller 606 of the system 600 may control one or more processes such as injection of displacement fluid 660 into the well head 640, control of the depressurization line 608, and the like. The controller 606 may include a processor 662, a memory 664 including instructions 666 executable by the processor 662, communication component 668, one or more additional components, or any combination thereof. The processor 662 may include single-threaded processor(s), multi-threaded processor(s), or both. The processor 662 may process instructions 666 stored in the memory 664. The processor 662 may also include hardware-based processor(s) each including one or more cores. The processor 662 may include general purpose processor(s), special purpose processor(s), or both. The processor 662 may be communicatively coupled to other components of the system 600.

The memory 664 may be any suitable articles of manufacture that can serve as media to store processor-executable code, data, or the like. These articles of manufacture may represent computer-readable media (e.g., any suitable form of memory or storage) that may store the processor-executable code used by the processor 662 to perform the presently disclosed techniques. As used herein, applications may include any suitable computer software or program that may be installed onto the controller 606 and executed by the processor 662. The memory 664 may represent non-transitory computer-readable media (e.g., any suitable form of memory or storage) that may store the processor-executable code (e.g., the instructions 666) used by the processor 662 to perform various techniques described herein. It should be noted that non-transitory merely indicates that the media is tangible and not a signal.

The communication component 668 may include a wireless or wired communication component (e.g., circuitry) that may facilitate communication between the controller 606, various types of valves, TSLL components, and/or components of system 600. Additionally, the communication component 668 may facilitate data transfer to the controller 606, such that the controller 606 may receive data from the other components of the system 600. The communication component 668 may use a variety of communication protocols, such as Open Database Connectivity (ODBC), TCP/IP Protocol, Distributed Relational Database Architecture (DRDA) protocol, Database Change Protocol (DCP), HTTP protocol, other suitable current or future protocols, or combinations thereof.

In some implementations, the CCS injection testing system 604 may include a flow path 670, where a fluid (e.g., CO₂) flows from the CO₂ tanks 612 through the CO₂ pump 614, the angle valve 616, the globe valve 618, the shutdown valve 622, the coil steam exchangers 624, the shell and tube steam exchanger 626, the Coriolis meter 628, and the high pressure hose 630, to the well head 640. The CO₂ may displace fluid in a reservoir associated with the well head 640. The CO₂ may become trapped in a volume of the closed system. . . . In some implementations, the displacement fluid 660 of the displacement fluid supply line 610 may be introduced via a flow path 672 to the well head 640. In some cases, the displacement fluid 660 of the displacement fluid supply line 611 may be introduced via a flow path 673 to the well head 640. The displacement fluid 660 may include non-reactive fluids, such as one or more inert gases (e.g., nitrogen (N₂), argon (Ar)), methanol, flue gas, air, steam, mono ethylene glycol, and the like. The controller 606 may control the depressurization system 602 to perform a displacement process of the closed system by causing one or both of the displacement fluid supply lines 610, 611 to inject displacement fluid 660 into the well head 640 while keeping the pressure above the saturation pressure. The displacement process may include bleeding off CO₂ via the flow path 672 and/or the flow path 673 or a flow path 674. The CO₂ may be injected into a well through the flow path 670 and/or 672 as the displacement fluid 660 replaces the volume of the trapped CO₂.

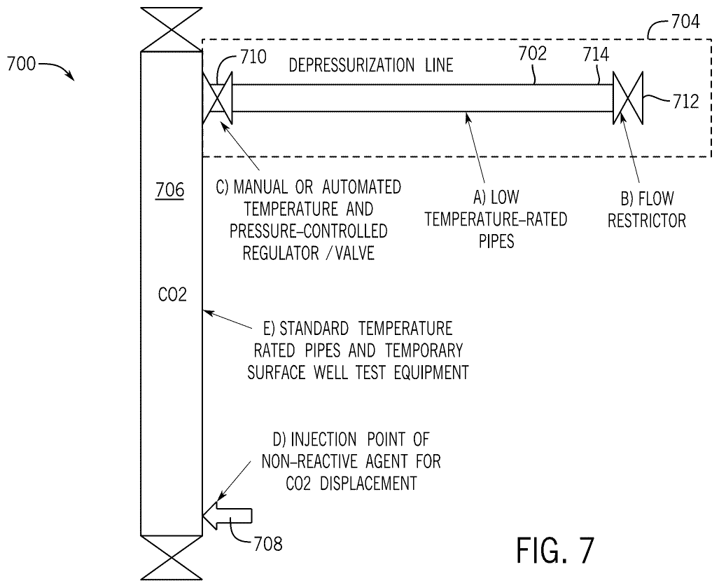

FIG. 7 is a schematic illustration 700 of an embodiment of a depressurization line 702 of a depressurization system 704, in accordance with aspects of the present disclosure. The depressurization line 702 may be coupled to a pipe 706 (e.g., fluid conduit or line). Although illustrated as one straight pipe 706, the pipe 706 may include any number, shapes, or arrangements of pipes and associated equipment, such as illustrated in FIG. 6. For example, the pipe 706 may include straight pipes, curved pipes, pipe bends or elbows, flow splitters, flow combiners, manifolds, and various equipment between sections of the pipe. In certain embodiments, the depressurization system 704 may reduce the pressure of the closed system (e.g., pipe 706) by bleeding off the pressure while keeping the pressure in the closed system (e.g., pipe 706) above the saturation pressure of CO₂.

The pipe 706 may be a standard temperature rated pipe and may include one or more additional pieces of equipment. For example, the pipe 706 may be 150, 300, 600, 900, and the ASME B16.5 rated for classes rated for pressure conditions ranging from 285 psi to 2200 psi and temperatures from −20° F. to 600° F. The one or more additional pieces of equipment may include a choke manifold rated for 5,000 or 10,000 psi and −20 to 250° F., a data header rated for 5,000 or 10,000 psi and −20 to 250° F., a conventional heat exchanger rated for 5,000 or 10,000 psi with a working temperature in the range from about −20 to 350° F., and the like The pipe 706 may include an injection point 708 for injection of a displacement fluid (e.g., a non-reactive agent) for CO₂ displacement. The depressurization line 702 may be coupled to the pipe 706 via a valve 710. The valve 710 may be a manual or automated temperature and pressure controlled valve and/or regulator. In some implementations, the valve 710 may be a manual or automated flow control valve with a variable internal diameter to regulate the CO₂ flow rate according to the pressure and temperature of the trapped CO₂. For example, the valve 710 may include a cryogenic globe valve. The depressurization line 702 may be a low temperature rated pipe to facilitate bleed-off of CO₂ from the pipe 706 via the valve 710. The depressurization line 702 may include a flow restrictor 712 configured to minimize fluid loss while enabling trapped air to escape. The flow restrictor 712 may include a fixed or variable internal diameter installed at an end 714 of the depressurization line 702 to provide back pressure to reduce the Joule-Thomson effect in the pipe 706.

In some implementations, the depressurization line 702 may include low-temperature rated pipes capable of handling fluids at much lower temperatures compared to the rest of a surface facility (e.g., the pipe 706). The depressurization line 702 may be able to handle fluids at temperatures of less than or equal to −100° C., −140° C., −150° C. The depressurization line 702 may be connected to the surface facility to allow for the safe release of CO₂ into the atmosphere in a designated safe area. In operation, the depressurization system 704 controls the supply of the displacement fluid (e.g., nitrogen) into the closed system (e.g., pipe 706) and controls the discharge of the trapped CO₂ through the depressurization line 702, thereby controlling the pressure in the closed system (e.g., pipe 706) to not exceed the saturation pressure of CO₂. Thus, by controlling the pressure in the closed system (e.g., pipe 706) below the saturation pressure of CO₂, the depressurization system 704 helps to reduce the possibility of sudden pressure and temperature changes that can lead to solidification of the CO₂ in the closed system (e.g., pipe 706).

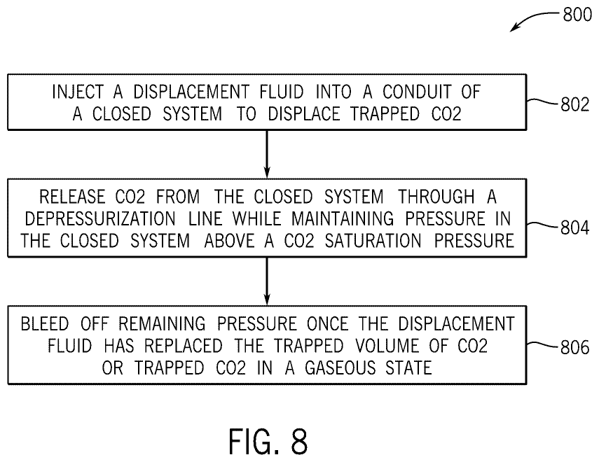

FIG. 8 is a flow chart of an embodiment of a process 800 for injecting a displacement fluid (e.g., an auxiliary fluid) to release CO₂ through a depressurization line, in accordance with aspects of the present disclosure. Blocks (e.g., steps or procedures) of the process 800 may be performed by elements of the system 600 of FIG. 6 and/or the system 700 of FIG. 7, such as the depressurization system 602, the depressurization system 704, and/or the controller 606 discussed herein or any additional suitable system. It should be noted, that the illustrated blocks are provided as examples and more, fewer, or different blocks may be included in the process 800.

At block 802 of the process 800, the displacement system may inject a displacement fluid into a conduit of a closed system to displace trapped CO₂. The displacement fluid may include a displacement fluid such as a non-reactive fluid. The displacement fluid may be nitrogen, methanol, flue gas, air, argon, mono ethylene glycol, and the like. The closed system may include a portion of reservoir, a portion of well-testing equipment, and the like. The closed system may include a volume of trapped CO₂. The trapped CO₂ may be in a liquid or supercritical state at a specific pressure and temperature. The displacement fluid may be injected into the closed system at a controlled rate. The controlled rate may be based on a pressure and/or temperature of the closed system and/or the trapped CO₂.

At block 804 of the process 800, the displacement system may release CO₂ from the closed system through a depressurization line while maintaining pressure in the closed system above a CO₂ saturation pressure. The controller of the depressurization system may control a bleed-off rate of the CO₂ through the depressurization line to maintain the pressure in the closed system above the CO₂ saturation pressure to reduce the possibility of formation of solid CO₂ in the closed system. The controlled pressure bleed-off process of the trapped CO₂ volume in gas, liquid, and supercritical states. The controlled pressure bleed-off process may reduce the possibility of pressure increases in the closed system due to surrounding heat. In some implementations, the controlled pressure bleed-off may be used at an end of well-testing prior to equipment decommissioning to displace CO₂ and depressurize the closed system.

At block 806 of the process 800, the displacement system may bleed off remaining pressure once the displacement fluid has replaced the trapped volume of CO₂ or trapped CO₂ in a gaseous state. In some implementations, the displacement system may control the depressurization line to release the displacement fluid and/or gaseous CO₂ from the closed system upon displacement of the CO₂ in the liquid and/or supercritical phase. In this manner, the CO₂ may be removed from the closed system while maintaining pressure and temperature within a range of operating conditions in accordance with pressure and temperature limits of the closed system. The depressurization line of the displacement system may be rated for cryogenic temperatures to handle low temperatures of CO₂ during the bleed-off process.

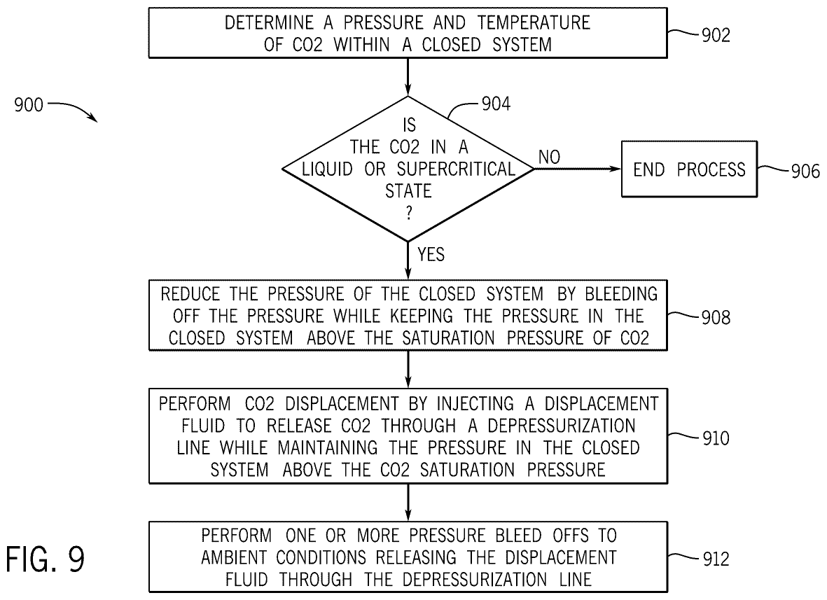

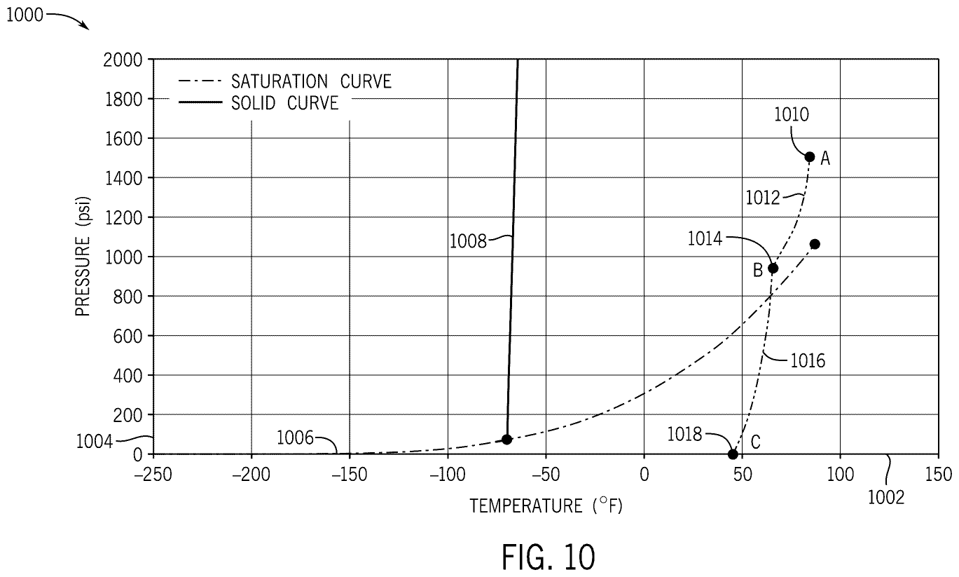

FIG. 9 is a flow chart 900 of an embodiment of a process for performing CO₂ displacement by injecting a displacement fluid through a depressurization line, in accordance with aspects of the present disclosure. FIG. 10 is a graph 1000 illustrating a phase envelope of CO₂ 1002 during a depressurization process from initial to ambient conditions. To facilitate discussion, FIGS. 9 and 10 will be discussed below concurrently. Blocks (e.g., steps or procedures) of the process 900 may be performed by elements of the system 600 of FIG. 6 and/or the depressurization system 704 of FIG. 7, such as the depressurization system 602, the depressurization system 704, and/or the controller 606 discussed herein or any additional suitable system. It should be noted, that the illustrated blocks are provided as examples and more, fewer, or different blocks may be included in the process 900.

The graph 1000 includes an x-axis 1002 of temperature in Fahrenheit (° F.) and a y-axis 1004 of pressure in pounds per square inch (psi). The graph 1000 includes a CO₂ saturation curve 1006, and a CO₂ solid curve 1008. The saturation curve 1006 represents the non-linear relationship between pressure and temperature where the CO₂ coexists as liquid and vapor in equilibrium. The CO₂ solid curve 1008 represents the solid-liquid equilibrium curve of a boundary where CO₂ exists simultaneously as a solid and a liquid.

At block 902 of the process 900, the depressurization system may determine a pressure and temperature of CO₂ within a closed system. In some implementations, the pressure and temperature of CO₂ may be measured via one or more sensors such as a pressure gauge and/or a temperature sensor. At block 904 of the process 900, the depressurization system may determine if the CO₂ is in a liquid or supercritical state. The CO₂ may be determined to be in a gaseous state, in such cases, the process 900 may proceed to block 906 and end the process. In some cases, the pressure and temperature may be determined to be in the liquid or supercritical state and the process 900 may proceed to block 908. For example, the pressure and temperature of CO₂ may be determined to be at conditions represented by point A 1010 as shown in the graph 1000.

At block 908 of the process 900, the depressurization system may reduce the pressure of the closed system by bleeding off the pressure while keeping the pressure in the closed system above the saturation pressure of CO₂. The pressure may be reduced by gradually by bleeding off the pressure slowly as shown by a first curve 1012 from point A 1010 to point B 1014. At block 910 of the process 900, the depressurization system may perform CO₂ displacement by injecting a displacement fluid to release CO₂ through a depressurization line while maintaining the pressure in the closed system above the CO₂ saturation pressure. The trapped CO₂ volume may be displaced to the displacement fluid by releasing the CO₂ through the depressurization line to the atmosphere as represented by point B 1014.

At block 912 of the process 900, the depressurization system may perform one or more pressure bleed offs to ambient conditions, releasing the displacement fluid through the depressurization line. The pressure bleed-off is represented by a second curve 1016 from point B 1014 to point C 1018. The pressure may reduce from about 400 psi to about 0 psi, releasing the CO₂ through the depressurization line.

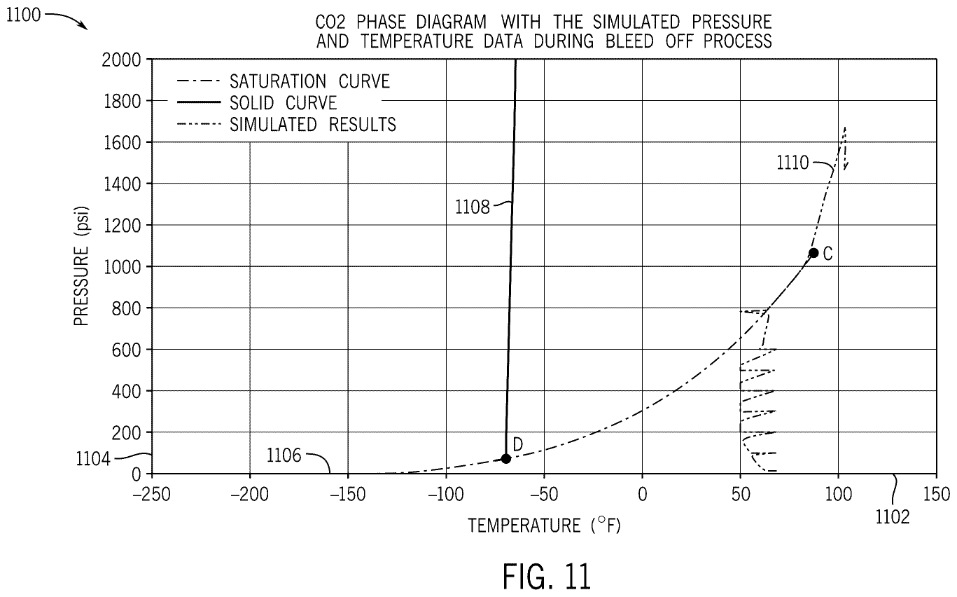

FIG. 11 is a graph 1100 illustrating a phase envelope of CO₂ including simulated pressure and temperature during the depressurization process of FIG. 11, according to one or more examples of the disclosure. The graph 1100 includes an x-axis 1102 of temperature in Fahrenheit (° F.) and a y-axis 1104 of pressure in pounds per square inch (psi). The graph 1100 includes a CO₂ saturation curve 1106, and a CO₂ solid curve 1108. The saturation curve 1106 represents the non-linear relationship between pressure and temperature where the CO₂ coexists as liquid and vapor in equilibrium. The CO₂ solid curve 1108 represents the solid-liquid equilibrium curve of a boundary where CO₂ exists simultaneously as a solid and a liquid.

The graph 1100 illustrates simulation results using a transient process simulator of the pressure bleed-off process for trapped CO₂ in a supercritical state, starting from an initial pressure of 1500 psi and a temperature of 104° F., down to ambient conditions as shown by line 1110. The pressure bleed-off process involves displacing the CO₂ volume by N₂ gas above the CO₂ saturation point, followed by the subsequent bleed-off of N₂ gas keeping the temperature within the design criteria of standard equipment.

Technical effects of the disclosed embodiments include a displacement system including a displacement line to preserve standard well-test equipment from low temperatures during depressurization of trapped carbon dioxide (CO₂) in well testing equipment. The depressurization system may be used to displacing a volume of well-test equipment occupied by CO₂ with a displacement fluid. The displacement fluid may include a non-reactive gas or liquid such as nitrogen, methanol, flue gas, air, argon, mono ethylene glycol, and the like. The depressurization system may be used to control a pressure bleed-off process through a depressurization line of the depressurization system. Advantageously, use of the depressurization system may reduce overall operational costs if well testing, and enhance safety by displacing trapped CO₂ with non-reactive fluids through the depressurization line specifically designed to handle CO₂ temperature and pressure limits. As such, deployment of the presently disclosed techniques may provide improved efficiency and performance of removing trapped CO₂ from closed systems.

The subject matter described in detail above may be defined by one or more clauses, as set forth below.

A method of depressurizing a volume of trapped CO₂. The method includes injecting displacement fluid in a closed system to displace the volume of trapped CO₂ and releasing the trapped CO₂ out of the trapped system through a depressurization line while maintaining pressure in the closed system above a CO₂ saturation pressure.

The method of the preceding clause, wherein the displacement fluid is a non-reactive fluid.

The method of any of the preceding clauses, wherein the displacement fluid is nitrogen, methanol, mono ethylene glycol, or argon.

The method of any of the preceding clauses, wherein the displacement fluid is injected at a first end of the closed system and the depressurization line is provided at a second end of the closed system opposite to the first end.

The method of any of the preceding clauses, wherein the closed system is rated to withstand a first temperature range and wherein the depressurization line is rated to withstand a second temperature range, a low end of the second temperature range being lower than a low end of the first temperature range.

The method of any of the preceding clauses, wherein the low end of the first temperature range is less than or equal to −50° C., and wherein the low end of the second temperature range is less than −100° C.

The method of any of the preceding clauses, wherein the trapped CO₂ is released to the atmosphere through the depressurization line.

The method of any of the preceding clauses, including, before injecting the displacement fluid, reducing the pressure of the closed system by bleeding off the pressure while maintaining the pressure in the closed system above the CO₂ saturation pressure.

The method of any of the preceding clauses, including, after injecting the displacement fluid, reducing the pressure by gradually bleeding-off the pressure by releasing the displacement fluid through the depressurization line while maintaining a temperature in the closed system within a first temperature range.

A depressurization system is provided herein. The depressurization system includes a closed system, including at least a conduit, configured to include a volume of trapped CO₂ and an injection inlet coupled to a first portion of the closed system, wherein the injection inlet is configured to inject a displacement fluid into the closed system. The depressurization system also includes a depressurization line coupled to a second portion of the closed system, wherein the first and second portions are offset from one another. The depressurization system also includes a cryogenic valve coupled to the depressurization line, wherein the cryogenic valve is configured to control a release of the trapped CO₂ out of the closed system through the depressurization line.

The depressurization system of the preceding clause wherein the injection inlet is positioned upstream of the closed system.

The depressurization system of any of the preceding clauses, wherein the depressurization line is connected downstream of the closed system.

The depressurization system of any of the preceding clauses, wherein the closed system comprises one or more CO₂ tanks, one or more coil steam exchangers, a shell and tube steam exchanger, a Coriolis meter, or any combination thereof.

The depressurization system of any of the preceding clauses, wherein the displacement fluid is a non-reactive fluid.

A method includes determining if a volume of trapped CO₂ within a closed system is in a liquid or supercritical state and in response to the volume of trapped CO₂ being in the liquid or supercritical state, reducing the pressure of the closed system by bleeding off the pressure while keeping the pressure in the closed system above the saturation pressure of CO₂. The method also includes injecting a displacement fluid to release CO₂ through a depressurization line while maintaining the pressure in the closed system above the CO₂ saturation pressure and performing one or more pressure bleed offs to ambient conditions releasing the displacement fluid through the depressurization line.

The method of the preceding clause, wherein the displacement fluid is a non-reactive fluid.

The method of any of the preceding clauses, wherein the displacement fluid is nitrogen.

The method of any of the preceding clauses, including determining if the volume of trapped CO₂ within the closed system is in a gaseous state; and in response to the volume of trapped CO₂ being in the gaseous state, ending the one or more pressure bleed offs.

The method of any of the preceding clauses, wherein the depressurization line is connected downstream of the closed system.

The method of any of the preceding clauses, wherein the displacement fluid is configured to be injected via an injection point.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

What is claimed is:

1. A method of depressurizing a volume of trapped CO₂, comprising:
injecting displacement fluid in a closed system to displace the volume of trapped CO₂; and
releasing the trapped CO₂ out of the closed system through a depressurization line while maintaining pressure in the closed system above a CO₂ saturation pressure.

2. The method of claim 1, wherein the displacement fluid is a non-reactive fluid.

3. The method of claim 1, wherein the displacement fluid is nitrogen, methanol, mono ethylene glycol, or argon.

4. The method of claim 1, wherein the displacement fluid is injected at a first end of the closed system and the depressurization line is provided at a second end of the closed system opposite to the first end.

5. The method of claim 1, wherein the closed system is rated to withstand a first temperature range and wherein the depressurization line is rated to withstand a second temperature range, a low end of the second temperature range being lower than a low end of the first temperature range.

6. The method of claim 5, wherein the low end of the first temperature range is less than or equal to −50° C., and wherein the low end of the second temperature range is less than-100° C.

7. The method of claim 1, wherein the trapped CO₂ is released to the atmosphere through the depressurization line.

8. The method of claim 1, comprising, before injecting the displacement fluid, reducing the pressure of the closed system by bleeding off the pressure while maintaining the pressure in the closed system above the CO₂ saturation pressure.

9. The method of claim 1, comprising, after injecting the displacement fluid, reducing the pressure by gradually bleeding-off the pressure by releasing the displacement fluid through the depressurization line while maintaining a temperature in the closed system within a first temperature range.

10. A depressurization system, comprising
a closed system, including at least a conduit, configured to include a volume of trapped CO₂;
an injection inlet coupled to a first portion of the closed system, wherein the injection inlet is configured to inject a displacement fluid into the closed system;
a depressurization line coupled to a second portion of the closed system, wherein the first and second portions are offset from one another; and
a cryogenic valve coupled to the depressurization line, wherein the cryogenic valve is configured to control a release of the trapped CO₂ out of the closed system through the depressurization line.

11. The depressurization system of claim 10, wherein the injection inlet is positioned upstream of the closed system.

12. The depressurization system of claim 10, wherein the depressurization line is connected downstream of the closed system.

13. The depressurization system of claim 10, wherein the closed system comprises one or more CO₂ tanks, one or more coil steam exchangers, a shell and tube steam exchanger, a Coriolis meter, or any combination thereof.

14. The depressurization system of claim 10, wherein the displacement fluid is a non-reactive fluid.

15. A method, comprising:
determining if a volume of trapped CO₂ within a closed system is in a liquid or supercritical state;
in response to the volume of trapped CO₂ being in the liquid or supercritical state, reducing a pressure of the closed system by bleeding off the pressure while keeping the pressure in the closed system above the saturation pressure of CO₂;
injecting a displacement fluid to release CO₂ through a depressurization line while maintaining the pressure in the closed system above the saturation pressure of CO₂; and
performing one or more pressure bleed offs to ambient conditions releasing the displacement fluid through the depressurization line.

16. The method of claim 15, wherein the displacement fluid is a non-reactive fluid.

17. The method of claim 15, wherein the displacement fluid is nitrogen.

18. The method of claim 15, comprising:
determining if the volume of trapped CO₂ within the closed system is in a gaseous state; and
in response to the volume of trapped CO₂ being in the gaseous state, ending the one or more pressure bleed offs.

19. The method of claim 15, wherein the depressurization line is connected downstream of the closed system.

20. The method of claim 15, wherein the displacement fluid is configured to be injected via an injection point.
